(19) United States
(12) Patent Application Publication
(10) Pub. No.: US 2002/0117402 A1
(43) Pub. Date: Aug. 29, 2002

(54) Magneto-hydrodynamic tile for filtration and electric power generation

(76) Inventor: Arthur Roy Collins, Oklahoma City, OK (US)

Correspondence Address: MICHAEL E. MARTIN, GARDERE WYNNE SEWELL, SUITE 3000, 1601 ELM STREET, DALLAS, TX, 75201, US

(21) Appl. No.: 10/080,863

(22) Filed: Feb. 22, 2002

Related U.S. Application Data
(60) Provisional application No. 60/271,162, filed on Feb. 26, 2001.

(51) Int. Cl. C02F 1/461

(52) U.S. Cl. 205/742; 204/242; 204/275.1

(57) ABSTRACT

A porous ceramic multi-layered tile device may be used to filter and treat fluids flowing therethrough and/or be capable of generating electrical energy in response to fluid flow. Tiles may be formed of compositions which include silica clays, iron and copper sulfides, tin, borax and titanium dioxide prepared in a slurry with water in a 1:1 weight ratio and to which particulate charcoal is added in a 1:1 volume ratio. A dried greenware tile is fired at an elevated temperature to burn off the charcoal to provide a selected porosity. Movement of ionized or ionizable fluids through the device may take advantage of magneto-hydrodynamic effects to remove contaminants from the fluid flowstream, and/or alter the composition of contaminants, such as hydrocarbons, in the flowstream. Combustion products from a flamefront may be passed through the device to generate electrical energy across opposed conductive outer layers of the tile.

### CROSS-REFERENCE TO RELATED APPLICATION

This application claims the priority of U.S. Provisional Patent Application Serial No. 60/271,162 filed Feb. 26, 2001.

### BACKGROUND OF THE INVENTION

Various ultra filtration, catalytic processes and electrolysis processes are known which provide for micro-filtration, chemical combinations for reductions or otherwise convert compositions or extract compositions using oxidation or hydration processes. However, many filtration or chemical conversion processes are complicated, expensive and not well suited for many situations where the filtration or decontamination of liquids and gases is required. However, magneto-hydrodynamic (MHD) phenomena can be utilized in filtration and decontamination processes and can provide certain advantages in electrical power generation applications. It is to these ends that the present invention has been developed.

### SUMMARY OF THE INVENTION

The present invention provides an improved filtration and conversion device for filtration and decontamination or conversion of fluids in both liquid and gaseous form. The present invention also provides a unique electrical power generator utilizing the effects of magneto-hydrodynamics.

The present invention further provides a method of providing a device which may be used for treatment of fluids including filtration, decontamination, chemical composition conversion and electrical power generation and which device may be characterized as a magneto-hydrodynamic tile.

The device of the invention functions unlike conventional catalysis which depends on a transient chemical incidental contact with a strong valent bond site. The device of the invention electro-magnetically stabilizes and polarizes the molecular spin of reactive materials in bulk as a path through strongly magnetized pulsating fields. Reactions in the device are further driven by the mechanical structure of the device. Localized electric discharges overcome the valent bond of water molecules, for example, and other complex compounds passing through the device may be caused to disassociate into inert salts, free hydrogen, oxygen and ozone molecules, for example.

The device of the invention may be used for many fluid filtration and decontamination applications including, for example, decontamination or conversion of exhaust gases from internal combustion engines and similar combustion processes. The high concentration of free radicals which are passing through the device cause the initiation and oxidation of combustible compositions, for example.

Those skilled in the art will further appreciate the advantages and superior features of the invention upon reading the detailed description which follows in conjunction with the drawings.

### BRIEF DESCRIPTION OF THE SEVERAL VIEWS OF THE DRAWINGS

FIG. 1 is an isometric view of a multi-layer tile in accordance with the invention illustrating its position relative to a fluid flowstream;

FIG. 2 is an isometric view of the tile shown in FIG. 1 illustrating one aspect of its self-cleaning capability;

FIG. 3 is an isometric view of a first alternate embodiment in accordance with the invention; and

FIG. 4 is an isometric view of a second alternate embodiment in accordance with the invention.

### DETAILED DESCRIPTION OF THE PREFERRED EMBODIMENTS

In the description which follows, like elements may be marked with the same reference numerals throughout the specification and drawings. The drawing figures are in generally schematic form in the interest of clarity and conciseness.

Reference numeral 1 indicates a tile device consisting of alternating layers of open porous materials A, B, and C, respectively. The first or front layer A consists of electrically conductive foam, formed by a series of small interconnecting chambers. The interface A′-B′ between the layers A and B is made by several overlapping layers of low micron size capillary pipettes forming a first, or front magneto-hydrodynamic “MHD” zone, that extends perpendicular to the respective planes of layers A and B. The second or center porous layer B is electrically nonconductive. The interface B′-C′ between the B layer and the third or last conductive porous layer C, is a second or back MHD zone of capillary pipettes.

A particle contaminated fluid flowstream, indicated by the arrows 7, contacts the frontal area 3 of tile 1, which serves as a fine sieve for suspended particles in the flowstream. As those captured particles reside on the forward facing surface 3 of the tile 1 they become electromagnetically polarized over time and become repelled by the tile 1 as indicated by the return arrow 4 in FIG. 2. Cascades of strong magnetic flux lines, shown as concentric rings 5, emanating from the center of tile 1 towards the peripheral edges, keep pushing collected debris toward the tile edges where it accumulates just beyond the periphery 6 of the tile 1 and the flowstream 7.

As gases and/or liquids begin to enter the porous substrate A, they are selectively polarized according to their chemical valence, and become highly charged in the flowstream 7. Electrodynamic forces turn responding molecules along a given axis and drive individual molecules into the front MHD zone A′-B′. Within zone A′-B′, the velocities of such molecules are disproportionately increased as they pass along with the consecutive flux lines 5 moving front to back. Their harmonic movement as waves substantially increases the probability of their making productive contact with the corresponding chemicals, beginning their reactions. These early flux conditions typically divert the most electrically conductive material out of the flowstream, forcing such material to accumulate at the periphery 6 of the tile 1. As the flowstream 7 moves deeper into the tile 1 it passes through a series of layers of microscopic pipettes, indicated as front and rear MHD zones A′-B′ and B′-C′, respectively. A series of interactive electrostatic charge and magnetic domains arise within the distinct layers of the multilayered substrate. Movement of ionized or ionizable gases, vapors, or liquids moving through charged layers, in turn deform static fields of adjoining regions, inducing further charge migrations between the layers of pipettes building additional surface charges within the cylindrical surfaces, also strengthening the magnetic moment between layers of tubes, as well as their end to end magnetic polarities, thus substantially enhancing electrolytic processes.

Ultra strong polarization of specific ionized materials, allows those compounds to be aggressively repelled in front of a particular charge zone, or drawn into electromagnetically charged pipette-like proclivities. The electromagnetically stressed compounds enter areas within this structure that may be chemically compounded to allow their maturation with free radicals, (hydroxyls and ozone generated by electrolysis within the pipettes). In this state they may induce complete oxidation of any complex molecule moving through those pipettes. In other applications, solutions and gases, which may be electromagnetically driven by flow gradient structures reflecting changes in surface tensions due to electrovalent charge values toward a particular zone for their high purity extraction.

The center layer B of the tile 1 is composed of electrically non-conductive materials. However, its high capacitance serves to reinforce the magnetic properties of the electromagnetic domains of earlier and later polarizing structures.

As stated above the back MHD zone B′-C′ comprises planes of aligned matrixes of pipettes. Like the front zone A′-C′ it also electromagnetically stabilizes and then polarizes the molecular spin of any remaining reactive materials. As such materials pass through these strongly magnetized pulsating fields, vapors or gases may continue to react and reorient their polarities, as they are being driven by strong electromotive forces moving along the strongly polarized length of the pipettes. Indiscernibly located electric discharges recombine the simplest valent bonds such as water molecules and simple oxides while in the channels or spaces of the tile 1. The expansion and contraction of the materials, and change in surface tensions cause them to positively migrate into the final porous layer C.

Metallic salts migrate to and accumulate at the edges of the aft face of the two inner layers A′-B′ and B′-C′ of pipette structures. Not all of the free hydrogen and ozone molecules convert back into water due to the stripping of ions from the ozone molecules in the final layer C. This results in higher than ambient levels of oxygen being released. This zone produces several magneto-hydrodynamic events that mimic catalysis materials.

One important feature of this device is that it prevents the reaction sites from being poisoned by mineral contaminants, as does those catalysis containing noble metals. Nor is this process susceptible to moderate fluctuations in the flowstream ph. A positive flowstream's distortion of internal electromagnetic fields is seen to generate excess electrical current, especially where excess heat is present. One test for premeditating flue gas, indicated available electric power at over 300,000 volts at 20 milliamps in a 375° F. exhaust gas flowstream, offering potential use of tile 1 as an inexpensive fuel cell. A 1,500 CFM and 375° F. exhaust gas stream at the forward area of tile 1 was reduced to 300 CFM flow at 93° F. exiting the aft face of the tile 1.

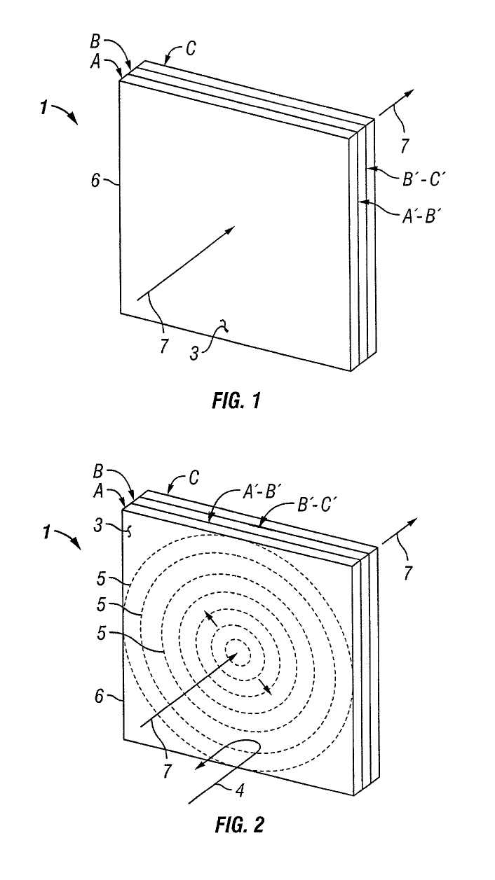

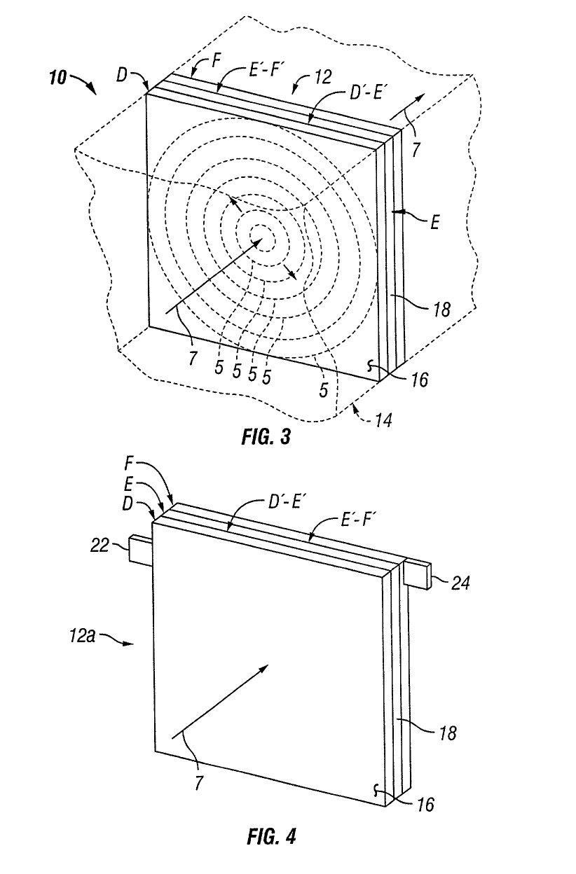

Referring now to FIG. 3, another embodiment of the invention is illustrated and generally designated by the numeral 10. The embodiment of FIG. 3 is characterized as a filtration or decontamination device comprising a magneto-hydrodynamic tile 12 substantially like the tile 1 but shown disposed within a duct 14 formed of electrically non-conductive material and adapted to guide a flowstream of fluid 7 through the tile 12 in generally the same manner as fluid flows through the tile 1. The tile 12 includes a first electrically conductive layer D substantially like the conductive layer A of tile 1, a second or intermediate and substantially electrically non-conductive layer E, a third and electrically conductive layer F and interfaces or zones B′-E′ and E′-F′ similar to the interfaces A′-B′ and D′-C′ of the embodiments of FIGS. 1 and 2. The tile 12 includes an outer face 16 of conductive layer D facing incoming flow from a flowstream of fluid 7 and a peripheral edge 18 defining the shape of the tile 12. The peripheral edge 18 is inclusive of the edges of the tile layers D, E and F and the edges of interfaces B′-E′ and E′-F′. The shape of the tile 12 as well as the tile 1 may be other than square or rectangular, as shown in the drawing figures. Virtually any peripheral outline or shape may be adapted including circular, for example. Fluids requiring filtration, decontamination, conversion or chemical change of at least some component of the fluid may be introduced into the electrically non-conductive duct 14 to flow through the porous structure of the tile 12. FIG. 3 also shows generally concentric magnetic flux lines 5 which form on the tile 12 as with the embodiment of FIGS. 1 and 2.

One preferred composition of the tile like device of the present invention and a method of forming the tile device 1 or 12 will now be described. In accordance with the invention a preferred composition of the tile 1 or 12 includes, by dry weight, 11% copper sulfide, 16% iron sulfide, 2% tin, 2%-3% titanium dioxide, 22% of a borate mineral, such as borax, and the remainder formed of one or more claylike material, such as silica clays. The above described composition, in generally fine particulate form, is thoroughly mixed with water in a weight ratio of 1:1, and is further prepared by adding thereto and thoroughly mixing therewith an equal volume of charcoal having a particle size of 70 microns to 230 microns for a tile device used for passing liquids therethrough. If a tile device 1 or 12 is to be used for the filtration or treatment of gases, the charcoal particle size should be in the range of about 230 microns to 0.125 inches.

A tile 1 or 12 of the above described composition may be formed by allowing the composition to air dry at normal room temperature in a plaster mold for about 24 hours. Orientation of the tile device is not important during the molding and drying process. The above-mentioned period of time is suitable for forming a “greenware” tile 1 or 12 having a square shape with outer dimensions of about 4.0 inches by 4.0 inches and 0.50 inches overall thickness, for example.

A tile 1 or 12 so formed in a plaster mold will undergo a shrinkage of about 4% to 8% and may be easily released from the mold. A greenware tile 1 or 12 as formed from the composition described above and by the method described above is then fired for a period of about 4.5 hours at a temperature of 1700° F.-1780° F. A tile 1 or 12 so formed as described hereinabove will be a rigid porous structure and the interfaces or zones A′-B′, B′-C′ as well as the interfaces or zones D′-E′ and E′-F′ will be formed as relatively thin layers of iron pyrites doped with boron. Moreover, the charcoal particulate material mixed throughout the composition of the tiles 1 or 12 will be burned away during the firing step leaving a structure which has porosity to allow fluid flow therethrough in substantially all directions.

After forming a tile 1 or 12 as described above all of the exterior faces of the tile are sanded lightly, including the peripheral edge 6 or 18, for example, to enhance the porosity of the surfaces and to prevent electrical conductivity between layers D and F across layer E or between layers A and C across layer B. In fact, as a consequence of the formation of a tile 1 or 12, as described above, layers A and C are electrically conductive while layer B becomes substantially electrically non-conductive. For the tile 12 layers D and F become electrically conductive and layer E is substantially non-conductive.

As previously described, substantially any liquid or gas flowing through the tile 1 or 12 generates strong electrical currents in the interfaces A′-B′, B′-C′, or interfaces D′-E′ and E′-F′, which currents flow generally towards the periphery or outer surface 18, for example. By way of example, if the tile 1 or 12 is used as a device for treating the exhaust gases from an internal combustion engine, such as a diesel engine, particulates and unburned hydrocarbons will be collected and forced toward the periphery of the tile and along the concentric flux lines 5. Moreover, the magneto-hydrodynamic effect of such gases passing through the tile will create hydroxyls releasing ozone, for example, at the interfaces A′-B′ and B′-C′ or D′ E′ and E′-F′ which will, in turn, oxidize unburned hydrocarbons passing through the tiles.

Moreover, a tile constructed in accordance with the composition and method described herein has been tested by flowing therethrough water containing chlorides, such as sodium chloride in the amount of at least 1,800 parts per million. Such a water composition flowing through a tile 1 or 12, constructed as described above, has been reduced to a chloride content as low as 100 parts per million upon passing through the tile.

As described hereinbefore, and as will be appreciated by those skilled in the art, the tile 12 may be modified as shown in FIG. 4 and designated by the numeral 12a. The tile 12a is substantially like the tile 12 except for the provision of electrodes or connectors 22 and 24 connected to the tile layers D and F, respectively. A flame front imposed on surface 16 from atmospheric combustion of hydrocarbons, for example, and operable to pass combustion gases and water vapor, at a relative humidity of about 50%, has been observed to generate an electrical potential of 830 volts across the electrodes 22 and 24 at 61 milliamps, thus proving the operability of the tile 12a as an electrical energy generator not unlike a fuel cell.

Although a unique device for treating fluids and/or for generating electrical energy, together with a composition and method of forming, has been described in detail hereinabove, those skilled in the art will recognize that various substitutions and modifications may be made to the invention without departing from the scope and spirit of the appended claims.

What is claimed is:

1. A device including a porous tile for treating a fluid flowing therethrough to remove contaminants therefrom or alter the composition of such fluid, said tile comprising:
plural layers of ceramiclike porous material including a first electrically conductive layer, a second substantially non-conductive layer and a third, substantially conductive layer, said tile being oriented to provide for flow of fluid therethrough while at least one of electromagnetically acting on components of said fluid to separate said components from a flowstream of said fluid passing through said tile and altering the composition of at least a component of said fluid passing through said tile.

2. The device set forth in claim 1 wherein:
said tile includes a first interface disposed generally between said first layer and said second layer and a second interface disposed generally between said second layer and said third layer, said interfaces being operable to force suspended particles in a flowstream of fluid flowing through said tile outwardly from a center portion of said tile along magnetic flux lines.

3. The device set forth in claim 2 wherein:
said interfaces are formed of pyrites.

4. The device set forth in claim 2 wherein:
said tile is operable to electromagnetically polarize particulates in said flowstream passing through said tile.

5. The device set forth in claim 1 wherein:
said tile is operable to generate an electric potential between said first layer and said third layer in response to passing a fluid flowstream of products of atmospheric combustion of hydrocarbons through said tile at an elevated temperature.

6. A device including a porous tile for treating a fluid flowing therethrough to remove contaminants or alter the composition of such fluid, comprising:
a mixture of silica clay and metal compounds treated to form multiple layers including an electrically conductive first layer, an electrically non-conductive second layer and an electrically conductive third layer, said first and second layers including a first interface therebetween and said second and third layers including a second interface therebetween, the porosity of said tile being adapted to allow passage of at least one of a liquid and a gas therethrough and being operable to remove at least one of selected contaminants from and convert components of said fluid by electrical charge attraction.

7. The device set forth in claim 6 wherein:
said tile includes a first face exposed to a flowstream of said fluid for directing said flowstream through said first layer, across said first interface, through said second layer, across said second interface and through said third layer to exit said tile.

8. The device set forth in claim 6 wherein:
said first layer and said second layer include electrodes connected thereto for generating an electrical potential between said electrodes in response to a fluid stream passing through said tile.

9. The device set forth in claim 7 wherein:
said tile comprises a mixture of a clay, and additional components selected from a group consisting of copper sulfide, iron sulfide, tin, borax, titanium dioxide and a removable filler of particulate material.

10. The device set forth in claim 9 wherein:
said tile is formed by mixing silica clay and said additional components with water and a particulate filler to form a mixture, allowing said mixture to harden to form a greenware tile and firing said greenware tile at an elevated temperature to remove said filler therefrom.

11. The device set forth in claim 10 wherein:
said filler comprises charcoal provided in a particle size range of from about 70 microns to about 0.125 inches.

12. The device set forth in claim 10 wherein:
said filler is added to said mixture in a volume ratio of about 1:1.

13. The device set forth in claim 10 wherein:
said mixture is allowed to air dry followed by firing at an elevated temperature.

14. The device set forth in claim 13 wherein:
said elevated temperature is in a range of about 1700° F. to 1800° F.

15. The device set forth in claim 6 wherein:
said interfaces comprise doped pyrite.

16. The device set forth in claim 15 wherein:
said doped pyrite is formed with a dopant comprising boron.

17. A method for making a porous tile device operable for one of treating a fluid flowing therethrough and for generating an electrical potential in response to fluid flowing therethrough, comprising the steps of:
providing predetermined quantities of clay and metal compounds in particulate form, mixing a quantity of water with said clay and metal compounds, mixing a particulate filler material with said water, clay and metal compounds to form a composition;
forming a tile of a dried and hardened quantity of said composition; and
firing said tile at an elevated temperature to form at least a first layer, a second layer and a third layer of said tile, said second layer being disposed between said first and third layers, said first and third layers being electrically conductive and said second layer being substantially non-conductive.

18. The method set forth in claim 17 wherein:
said composition includes predetermined quantities of copper sulfide, iron sulfide, tin, borax and titanium dioxide.

19. The method set forth in claim 17 wherein:
said filler material is provided as particulate charcoal having a particle size range of from 70 microns-0.125 inches.

20. The method set forth in claim 17 wherein:
said filler is added to a mixture of said clay and metal compounds in a volume ratio of about 1:1.

21. The method set forth in claim 17 wherein:
water is added to a mixture of said clay and metal compounds in a weight ratio of about 1:1.

22. The method set forth in claim 17 wherein:
the step of firing said tile is carried out at a temperature in the range of about 1700° F. 1780° F.
